(19) United States
(12) Patent Application Publication
(10) Pub. No.: US 2015/0192751 A1
(43) Pub. Date: Jul. 9, 2015

(54) SLIDABLE LIGHT FILTERING DEVICE WITH TWO FILTERS

(71) Applicant: Jin Chang Chung, Hsinchu Hsien (TW)

(72) Inventor: Jin Chang Chung, Hsinchu Hsien (TW)

(21) Appl. No.: 14/151,784

(22) Filed: Jan. 9, 2014

(51) Int. Cl. G02B 7/00

(52) U.S. Cl. CPC G02B 7/006

(57) ABSTRACT

A slidable light filtering device with two filters includes a casing having a recess therein; a middle section of the recess having a through window; two windings being at two opposite lateral sides of the casing; a sliding sheet capable of being received into the recess and being movable between the two lateral sides of the casing; each of two lateral sides of the sliding sheet being installed with a first permanent magnet; a middle section of the sliding sheet having two through holes; a first through hole being installed with a first filtering sheet; and a second through hole being installed with a second filtering sheet; an upper cover capable of covering an upper side of the casing; and an electric circuit board being installed in the recess and below the sliding sheet.

### FIELD OF THE INVENTION

The present invention relates to optical light filtering devices, and in particular to a slidable light filtering device with two filters.

### BACKGROUND OF THE INVENTION

Filtering sheets are used on the lenses of a camera. For a long term used camera, light intensity will vary in daytime. For strong daylight, some undesired IR or UV lights must be filtered out to cause the camera can capture desired light quantity for capture images, while in night, light intensity is low. Since IR and UV light still have the effect of enhancing image resolution. Thus at night, the lenses are not needed to filter the IR and UV light. Therefore, a camera needs two filter sheets to be used in different situations.

In one prior art design, a double filtering sheet structure is used to a camera to filter lights at different timings, in that one filtering sheet for passing strong light and one for passing weak light. A driving motor is used to drive the structure so that at a time, only one filtering sheet is aligned to the lenses. However, the size of the driving motor is larger and thus a large space is needed so that the whole structure is bulge, which is inconvenient for designing of a camera.

Therefore, there is an eager demand for a novel structure which can improve the prior art defects so as to provide a minor size of filtering sheet for reducing the size of the camera.

### SUMMARY OF THE INVENTION

Accordingly the object of the present invention is to resolve the above mentioned problem, and thus a slidable light filtering device with two filters is provides. In the present invention no motor is used and magnetic components are used to replace the prior art motor so that the whole size is reduced and the lifetime of light filtering structure is prolonged. In the present invention, by the attraction of windings and magnets, a double filter sheet structure is movable between two different positions so that at a time, only one filter sheet is aligned to the lens. The lens is suitable for two different light states, such as daytime and night. No motor is used, while the structure has a compact size and long lifetime.

To achieve above object, the present invention provides a slidable light filtering device with two filters, comprising a casing having a recess therein; a middle section of the recess having a through window; two windings being at two opposite lateral sides of the casing; in installation, the windings winding around the outer sides of the casing; the winding wires of the two windings being wound along identical directions, or opposite directions; a sliding sheet capable of being received into the recess and being movable between the two lateral sides of the casing; each of two lateral sides of the sliding sheet being installed with a first permanent magnet; a middle section of the sliding sheet having two through holes; a first through hole being installed with a first filtering sheet; and a second through hole being installed with a second filtering sheet; an upper cover capable of covering an upper side of the casing so that the sliding sheet being installed in a space between the casing and the caver; a middle section of the cover having a penetrating hole which is positioned to align to the window of the casing so that light passes through the penetrating hole will passes through the through window of the casing; and an electric circuit board being installed in the recess and below the sliding sheet; the electric circuit board having a through hole which is positioned with respective to that of the through window of the casing so that in installing state; the through window is overlapped with the through hole of the electric circuit board; as a result light can pass therethrough; the two windings being electrically connected to the electric circuit board.

### BRIEF DESCRIPTION OF THE INVENTION

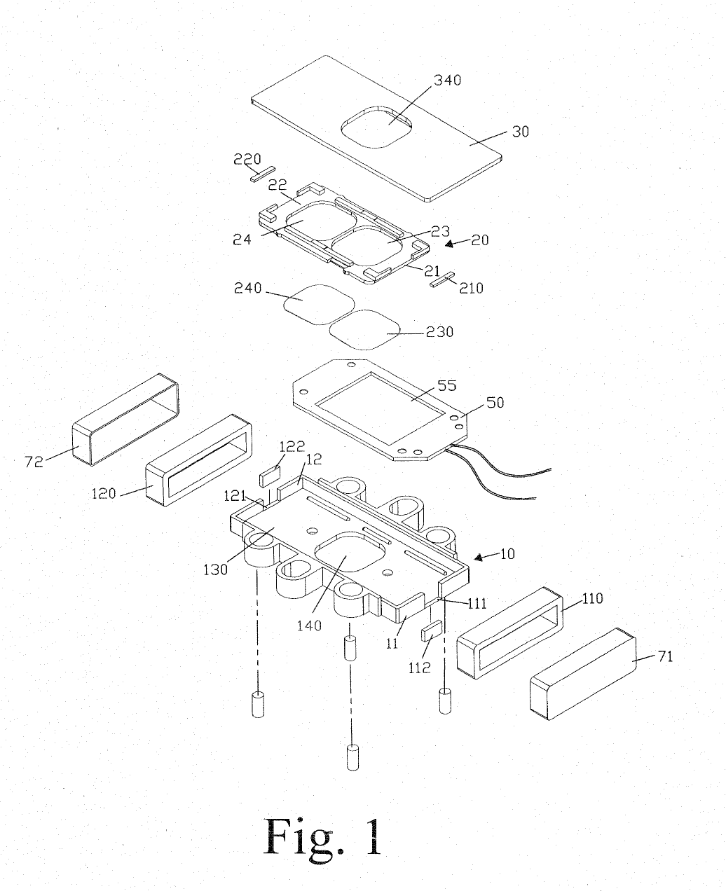

FIG. 1 is an exploded perspective view of the first embodiment of the present invention.

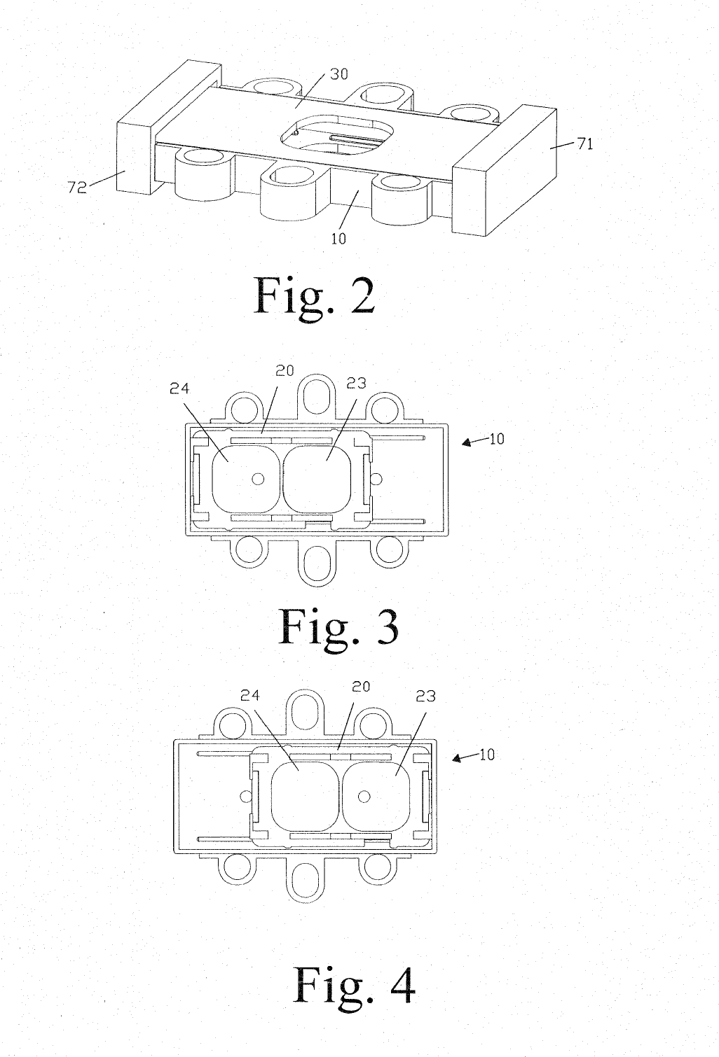

FIG. 2 is an assembled view about the first embodiment of the present invention.

FIG. 3 shows the operation of the present invention about the first embodiment of the present invention, where the filtering sheet moves leftwards.

FIG. 4 shows the operation of the present invention about the first embodiment of embodiment, where the filtering sheet moves rightwards.

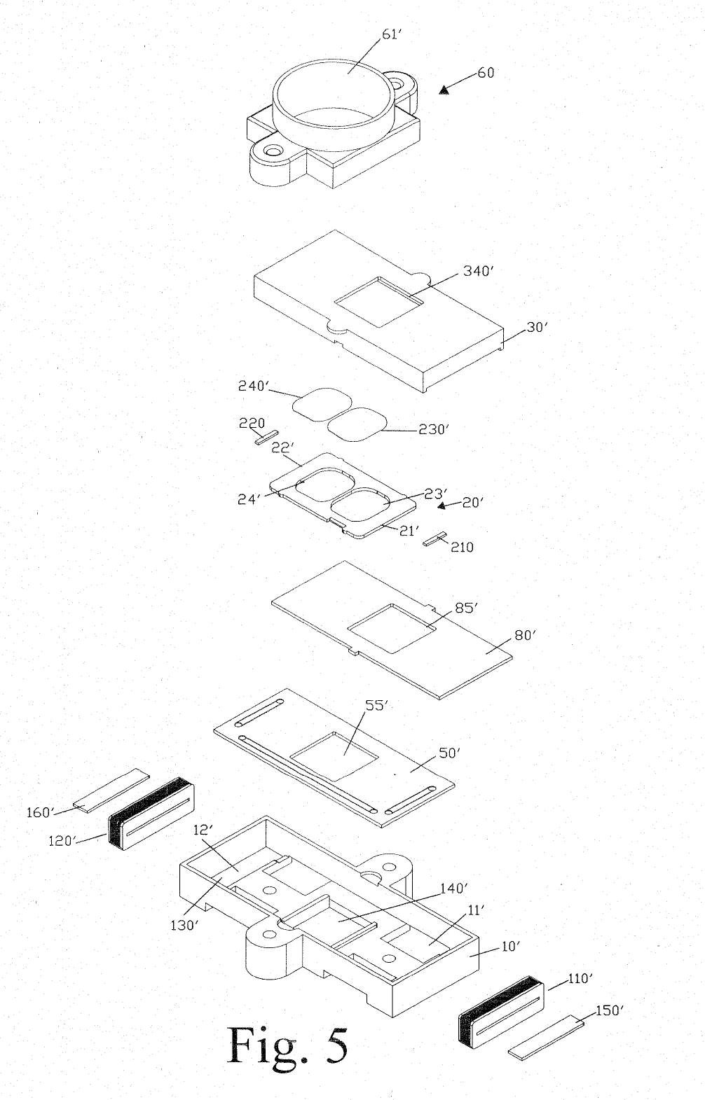

FIG. 5 is an exploded perspective view of the second embodiment of the present invention.

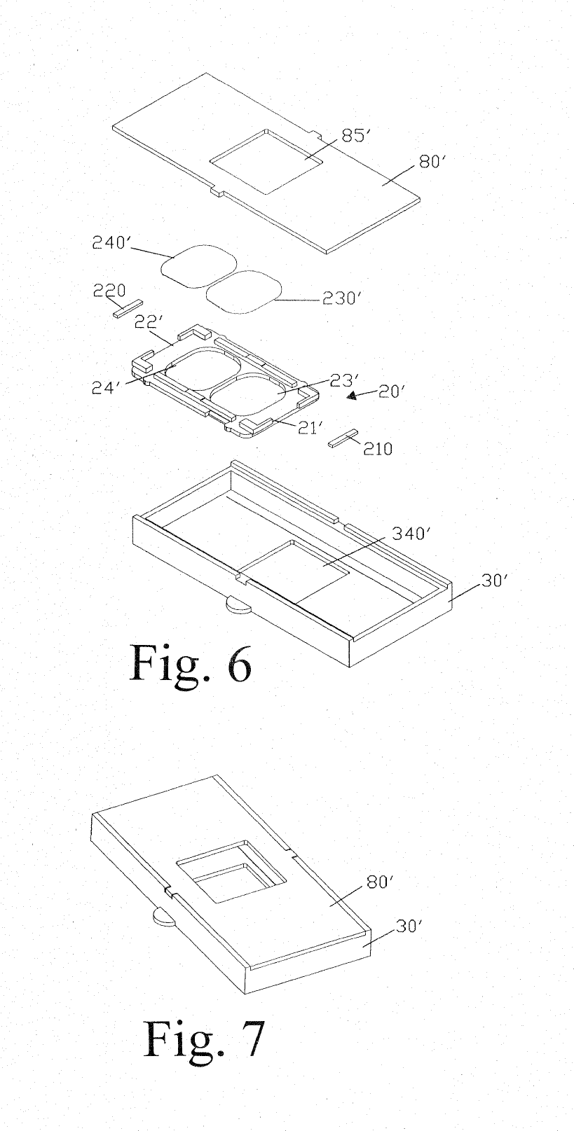

FIG. 6 is a down side view about the inner cover, sliding sheet and upper cover in the second embodiment of the present invention.

FIG. 7 is a first assembled schematic view about the second embodiment of the present invention.

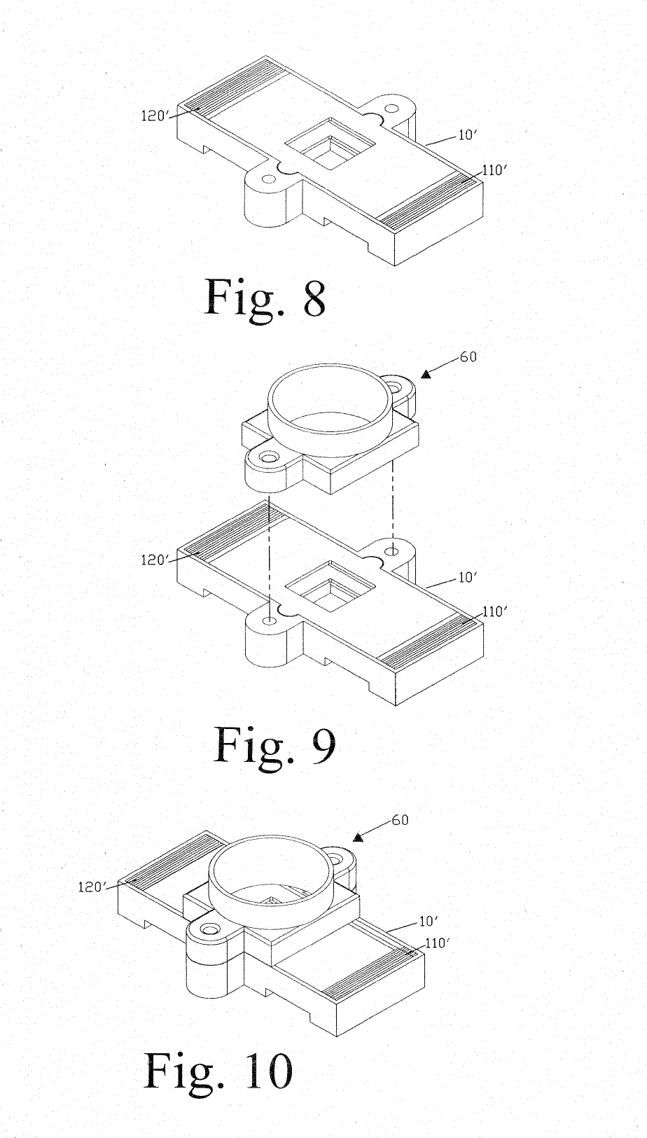

FIG. 8 is a second assembled schematic view about the second embodiment of the present invention.

FIG. 9 shows a first assembled view about the assembly of the lens housing to the casing.

FIG. 10 shows a second assembled view about the assembly of the lens housing to the casing.

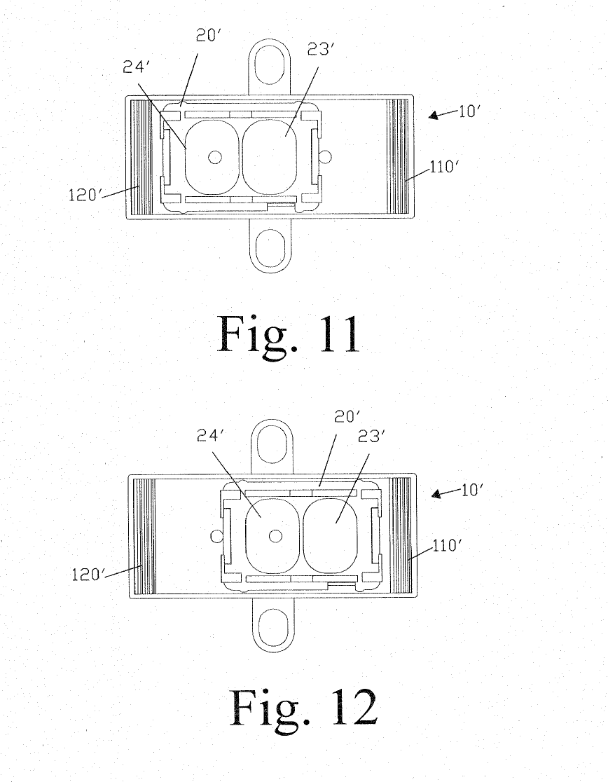

FIG. 11 shows the operation of the present invention about the second embodiment of the present invention, where the filtering sheet moves leftwards.

FIG. 12 shows the operation of the present invention about the second embodiment of embodiment, where the filtering sheet moves rightwards.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

A slidable light filtering device with two filters, comprises following elements:

A casing 10 has an oblong shape and having a recess 130 therein. A middle section of the recess 130 has a through window 140. Two windings 110, 120 are at two opposite lateral sides 11, 12 of the casing 10. In installation, the windings 110, 120 wind around the outer sides of the casing 10. The winding wires of the two windings 110, 120 are wound along identical directions, or opposite directions. For example, one winds clockwise as viewing from the right side of the casing 10, while another winds counterclockwise; or the two windings are all wound clockwise.

A sliding sheet 20 is capable of being received into the recess 130 and is movable between the two lateral sides 11, 12 of the casing (see FIGS. 3 and 4 and the following description). Each of two lateral sides 21, 22 of the sliding sheet 20 is installed with first permanent magnets 210, 220. A middle section of the sliding sheet 20 has two through holes 23, 24. A first through hole 23 is glued with a first filtering sheet 230; and a second through hole 24 is glued with a second filtering sheet 240.

An upper cover 30 is capable of covering an upper side of the casing 10 so that the sliding sheet 20 is installed in a space between the casing 10 and the cover 30. A middle section of the cover 30 has a penetrating hole 340 which is positioned to align the window 140 of the casing 10 so that light passes through the penetrating hole 340 will passes through the through window 140 of the casing 10.

An electric circuit board 50 is installed in the recess 130 and below the sliding sheet 20. The electric circuit board 50 has a through hole 55 which is positioned with respect to that of the through window 130 of the casing 10 so that in installing state, the through window 130 is overlapped with the through hole 55 of the electric circuit board 50. As a result, light can pass therethrough. The two windings 110, 120 are electrically connected to the electric circuit board 50.

Each of two lateral sides 11, 12 is formed with a respective notch 111, 121 for receiving a metal block 112, 122 (may be a permanent magnet or a non-permanent magnet).

Furthermore, in the present invention, two plastic films 71, 72 serve to enclose outer sides of the two windings 110, 120.

With reference to FIG. 3, based on electromagnetic law, when current flows through the two windings 110, 120, the two windings 110, 120 will generate magnetic fields. In the design of the present invention, the polarity of each windings 110 (120) is opposite to the polarity of a respective one of the two first permanent magnets 210 (220) nearest to the winding. For example, when one winding 110 is conducted, one of the two first permanent magnets 210 nearest to the conducted winding 110 will attract one another so that the sliding sheet 20 will move toward the conducted winding 110. Then the power flowing to the winding 110 is released. Since the notch 111 is installed with a metal block 112 so that the permanent magnet 210 will attract the metal block 112 and therefore the sliding sheet 20 is retained in this position. At this position, the filtering sheet 210 aligns the through window 140. The penetrating hole 340 of the cover 30 is aligned to the through window 140 of the casing 10, so that light passes through the penetrating hole 340 will pass through the through hole 23 of the sliding sheet 20 and is filtered by the filtering sheet 231 and then pass through the through hole 55 of the electric circuit board 50 and the through window 140 of the casing 10.

When at another time, another winding 120 is conducted, then the other permanent magnet 210 nearest to the conducted winding 120 will attract the winding 120 so that the sliding sheet 20 moves towards the winding 120. Similarly, when the power flowing to the winding 120 is turned off, by the attracting force to the winding 120 and the metal block 122, the sliding sheet 120 is fixed at this new position. At this position, the light passing through the penetrating hole 340 will pass through the filtering sheet 240 and then passing through the through hole 55 of the electric circuit board 50 and the through window 140 of the casing 10.

Thus, by above mentioned mechanism, the sliding sheet 120 can be controlled to at these two positions.

With reference to FIGS. 5 and 6, the second embodiment of the present invention will be described hereafter.

A slidable light filtering device with two filters, comprising:

A casing 10′ has an oblong shape and having a recess 130′ therein. A middle section of the recess 130′ has a through window 140′. Two windings 110′, 120′ are installed within the recess 130′ and at two opposite inner lateral sides 11′, 12′ of the casing 10′. The winding wires of the two windings 110′, 120′ are wound along identical directions, or opposite directions. For example, one winds clockwise as viewing from the right side of the casing 10′, while another winds counterclockwise; or the two windings are all wound clockwise. Each of the two windings 110′, 120′ is contained with a respective attractive sheet 150′, 160′. The attractive sheets 150′,160′ are magnetic metal sheets. One use of the sheets 150′,160′ is for guiding magnetic field of the windings 110′, 120′, respectively to flow through the attractive sheets so as to enhance the magnetic effects.

An electric circuit board 50′ is installed in the recess 130′. The electric circuit board 50′ has a through hole 55′ which is positioned with respective to that of the through window 130′ of the casing 10′ so that in installing state, the through window 140′ is overlapped with the through hole 55′ of the electric circuit board 50′. As a result light can pass therethrough. The two windings 110′, 120′ are electrically connected to the electric circuit board 50′.

An inner cover 80′ has a sheet like structure with a pass through hole 85′. In assembly state, the pass through hole 85′ of the inner cover 80′ is aligned to the through window 140′.

A sliding sheet 20′ is capable of being received into the recess 130′ and is movable between the two lateral sides 11′, 12′ of the casing. Each of two lateral sides 21′, 22′ of the sliding sheet 20 is installed with permanent magnets 210′, 220′. A middle section of the sliding sheet 20′ has two through holes 23′, 24′. A first through hole 23′ is glued with a first filtering sheet 230′; and a second through hole 24′ is glued with a second filtering sheet 240′. Another use of the sheets 150′, 160′ serves to magnetically attract with the permanent magnets 210′, 220′, respectively. As a result, when the sliding sheet 20′ moves rightwards due to the winding 110′ is electrically energized, the sheet 150′ will attract with the permanent magnet 210′. Thus the electricity to the windings 110′, 120′ can be released while retaining the attractions of the sheet 150′ with the permanent magnet 210. Thus, the sliding sheet 20′ is retained at the right side without any electricity in the windings. Similarly, by the same action with the energizing of the winding 160′, the sliding sheet 20′ can be retained at the left side without further power to energize the winding 160′.

An upper cover 30′ is capable of covering an upper side of the inner cover 80′ so that the sliding sheet 20′ is installed in a space between the inner cover 80′ and the upper cover 30′. A middle section of the upper cover 30′ has a penetrating hole 340′ which is positioned with respect to that of the window 140′ of the casing 10′.

Referring to FIG. 6, a down side view of the inner cover 80′, the sliding sheet 20′ and the upper cover 30′ is illustrated. The assembly of the inner cover 80′, sliding sheet 20′ and the upper cover 30′ will be described herein. In assembly, The sliding sheet 20′ with the permanent magnets 210′, 220′ and the first and second filtering sheets 230′, 240′ is placed on the inner cover 80′ and then the upper cover 30′ covers upon the inner cover 80′ so that the upper and inner covers are formed as a housing (referring to FIG. 7) for installing the sliding sheet 20′, while the pass through hole 85′ is aligned to the penetrating hole 340′ of the upper cover 30′. Then the housing is placed into the casing 10′ and is above the electric circuit board 50′ (referring to FIG. 8).

Furthermore, in the present invention, a lens housing 60′ (referring to FIG. 6) can be installed at an upper side of the cover 30′. The lens housing 60′ has a hollow center portion 61′ which is aligned to the penetrating hole 340′ of the cover 30′. FIGS. 9 and 10 show the assembly of the lense housing 60′ to the casing 10′ of the present invention.

The polarity of each windings 110′ (120′) is opposite to the polarity of a respective one of the two first permanent magnets 210′ (220′) near the winding. For example, when one winding 110′ is conducted, one of the two first permanent magnets 210′ near the conducted winding 110′ will attract one another so that the sliding sheet 20′ will move toward the conducted winding 110′. The mechanism of the user of the second embodiment is like that of the first embodiment, as those described above, while no metal block is used in the second embodiment. The operation of this embodiment is illustrated in FIGS. 11 and 12. FIG. 11 shows the operation of the present invention about the second embodiment of the present invention, where the filtering sheet moves leftwards. FIG. 12 shows the operation of the present invention about the second embodiment of embodiment, where the filtering sheet moves rightwards.

In the present invention, no motor is used and magnetic components are used to replace the prior art motor so that the whole size can be reduced and the lifetime of light filtering structure is prolonged. In the present invention, by the attraction of windings and magnets, a double filter sheet structure is movable between two different positions so that at a time, only one filter sheet is aligned to the lens so that the lens is suitable for two different light states, such as daytime and night. No motor is used, while the structure has a compact size and long lifetime.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A slidable light filtering device with two filters, comprising:
a casing having an oblong shape and having a recess therein; a middle section of the recess having a through window; two windings being at two opposite lateral sides of the casing; in installation, the windings winding around the outer sides of the casing; the winding wires of the two windings being wound along identical directions, or opposite directions;
a sliding sheet capable of being received into the recess and being movable between the two lateral sides of the casing; each of two lateral sides of the sliding sheet being installed with a first permanent magnet; a middle section of the sliding sheet having two through holes; a first through hole being installed with a first filtering sheet; and a second through hole being installed with a second filtering sheet;
an upper cover capable of covering an upper side of the casing so that the sliding sheet being installed in a space between the casing and the cover; a middle section of the cover having a penetrating hole which is positioned to align to the window of the casing so that light passes through the penetrating hole will passes through the through window of the casing; and
an electric circuit board being installed in the recess and below the sliding sheet; the electric circuit board having a through hole which is positioned with respective to that of the through window of the casing so that in installing state; the through window is overlapped with the through hole of the electric circuit board; as a result light can pass therethrough; the two windings being electrically connected to the electric circuit board.

2. The slidable light filtering device with two filters as claimed in claim 1, wherein each of two lateral sides is formed with a respective notch for receiving a metal block selected from one of a permanent magnet and a non-permanent magnet.

3. The slidable light filtering device with two filters as claimed in claim 1, wherein two plastic films serve to enclose outer sides of the two windings.

4. The slidable light filtering device with two filters as claimed in claim 2, wherein the polarity of each winding is opposite to the polarity of a nearest one of the two first permanent magnets;
Wherein when one of the two winding is conducted, one of the two first permanent magnets nearest the conducted winding will attract one another so that the sliding sheet will move toward the conducted winding; then the power flowing to the winding is released; since the notch is installed with the metal block so that the permanent magnet will attract the metal block and therefore the sliding sheet is retained in this position; at this position, the filtering sheet aligns the through window; the penetrating hole of the cover is aligned to the through window of the casing, so that light passes through the penetrating hole will pass through the through hole of the sliding sheet and is filtered by the filtering sheet and then pass through the through hole of the electric circuit board and the through window of the casing.

5. A slidable light filtering device with two filters, comprising:
a casing having an oblong shape and having a recess therein; a middle section of the recess having a through window; two windings being installed within the recess and at two opposite inner lateral sides of the casing; the winding wires of the two windings are wound along identical directions, or opposite directions;
an electric circuit board installed in the recess; the electric circuit board having a through hole which is positioned with respective to the through window of the casing so that in installing state, the through window being overlapped with the through hole of the electric circuit board; as a result light can pass therethrough; the two windings being electrically connected to the electric circuit board;
an inner cover having a sheet like structure with a pass through hole; in assembly state, the pass through hole of the inner cover being aligned to the through window;
a sliding sheet being capable of being received into the recess and being movable between the two lateral sides of the casing; each of two lateral sides of the sliding sheet being installed with permanent magnets; a middle section of the sliding sheet having two through holes; a first through hole being installed with a first filtering sheet; and a second through hole is installed with a second filtering sheet;
an upper cover being capable of covering an upper side of the casing so that the sliding sheet is installed in a space between the casing and the cover; a middle section of the cover having a penetrating hole which is positioned with respect to that of the window of the casing; and
wherein in assembly, the sliding sheet with the permanent magnets and the first and second filtering sheets is placed on the inner cover and then the upper cover covers upon the inner cover so that the upper and inner covers are formed as a cartridge for installing the sliding sheet, while the pass through hole is aligned to the penetrating hole of the upper cover; then the housing is placed into the casing and is above the electric circuit board.

6. The slidable light filtering device with two filters as claimed in claim 5, further comprising: a lens housing installed at an upper side of the cover; the lens housing having a hollow center portion aligned to the penetrating hole of the cover.

7. The slidable light filtering device with two filters, as claimed in claim 5, wherein the polarity of each winding is opposite to the polarity of a nearest one of the two first permanent magnets; when one winding is conducted, one of the two first permanent magnets near the conducted winding will attract one another so that the sliding sheet will move toward the conducted winding.

8. The slidable light filtering device with two filters, as claimed in claim 5, wherein each of the two windings is contained with a respective attractive sheet; the attractive sheets are magnetic attractive sheets for guiding magnetic field of the windings respectively to flow through the attractive sheets.

9. The slidable light filtering device with two filters, as claimed in claim 8, wherein the attractive sheets serve to magnetically attract with the permanent magnets;
when the sliding sheet moves to one side due to the winding of the side being energized, the attractive sheet will attract with the permanent magnet at that side; thus the electricity to the windings can be released while retaining the attractions of the sheet with the permanent magnet; thus, the sliding sheet is still retained at the that side without any electricity in the windings.
